(19) United States
(12) Patent Application Publication
(10) Pub. No.: US 2014/0181172 A1
(43) Pub. Date: Jun. 26, 2014

(54) OFFLOADING TETHERING-RELATED COMMUNICATION PROCESSING

(71) Applicant: Brent J. Elliott, Hillsboro, OR (US)

(72) Inventor: Brent J. Elliott, Hillsboro, OR (US)

(21) Appl. No.: 13/721,294

(22) Filed: Dec. 20, 2012

(51) Int. Cl. H04L 29/08

(52) U.S. Cl. CPC H04L 67/02
USPC 709/201

(57) ABSTRACT

This disclosure is directed to offloading tethering-related communication processing. In general, a communication processor in an intermediary device may be responsible for handling communication between tethered devices and a wide area network (WAN) like the Internet. In offloading responsibility for managing tethered devices to the communication processor, other processing resources (e.g., an applications processor) in the intermediary device may be both uninvolved and potentially totally isolated from the tethering, allowing the intermediary device to conserve power/processing resources, maintain better security, etc. An intermediary device may comprise, for example, a communication module to communicate with at least one other device and a WAN, a communication processor to control how information may be conveyed between the at least one other device and the WAN and an application processor, separate from the communication processor, to execute at least one application in the device.

### TECHNICAL FIELD

The present disclosure relates to device communication systems, and more particularly, to providing wide area network (WAN) access to other devices in a resource-efficient manner.

### BACKGROUND

The ability to interact via a wide area network (WAN) such as, for example, the Internet is quickly becoming essential functionality for modern electronic devices. Common devices that did not traditionally comprise communication resources such as, for example, various appliances, thermostats, automobiles, etc. are now able to utilize the Internet to communicate status updates, communicate emergency alerts, to provide control features to remote users, etc. However, while many devices now possess communication functionality, many of these devices are not able to access the Internet directly. Various limitations including, for example, size/space, power, cost, complexity, licensing, operating environment, etc. may limit devices to wired communication, to close-proximity or short-range wireless communication, etc. In these instances, a first device may act as a gateway to provide a conduit by which a secondary device may access the Internet.

A common example of a first device providing WAN access to another device includes a cable or digital subscriber line (DSL) modem connected to a wired or wireless access point (AP). This is a workable, but stationary, solution. The predominance of more advance mobile devices (e.g., smartphones) has allowed this type of access to become mobile, wherein secondary devices may be tethered to a cellular handset capable of Internet access employing third generation (3G) wireless technology, fourth generation (4G) wireless technology, etc. For example, a computing device such as a laptop computer, tablet computer, etc. may be “tethered” via a cable or a short-range wireless medium to a smart phone capable of providing access to the Internet. While this solution is workable and also mobile, other issues may arise. For example, higher complexity mobile devices may include substantial resource requirements just based on their own operation. Thus, tethering a separate device to a mobile device may increase the burden on already strained mobile device resources.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example of offloading tethering-related communication processing in accordance with at least one embodiment of the present disclosure;

FIG. 2 illustrates an example configuration for an intermediary device usable in accordance with at least one embodiment of the present disclosure;

FIG. 3 illustrates a communication example in accordance with at least one embodiment of the present invention; and

FIG. 4 illustrates example operations for offloading tethering-related communication processing in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to offloading tethering-related communication processing. In general, a communication processor in a device may be responsible for handling communication between tethered devices and a WAN (e.g., the Internet). Tethering, as referred to herein, may include a device configured as an intermediary by which tethered devices (e.g., devices coupled to the portal device via a wired or wireless communication) may access other tethered devices, a WAN, etc. More than one device may be concurrently tethered to the intermediary device. In offloading responsibility for managing tethered devices to the communication processor, other processing resources in the intermediary device (e.g., an applications processor) may be both uninvolved and potentially totally isolated from the tethered connections, allowing the device acting as the intermediary to conserve power/processing resources, maintain better security, etc.

In one embodiment, a device may comprise, for example, a communication module to communicate with at least one other device and a WAN, a communication processor to control how information may be conveyed between the at least one other device and the WAN and an application processor, separate from the communication processor, to execute at least one application in the device. An example communication processor may include network address translation (NAT) resources and at least one translation table to route communication packets between the at least one other device and the WAN. It is also possible for the communication processor to include a firewall to filter at least the communication packets between the at least one other device and WAN. In one embodiment, the communication module may communicate with the at least one other device via a short-range wireless network, may communicate with the WAN via a long-range wireless network, and the communication processor may be to route communication packets between the short-range and long-range wireless networks. It may also be possible for the communication module to communicate with WAN via at least one other short-range wireless network, and for the communication processor to cause the communication module to utilize the at least one other short-range wireless network instead of the long-range wireless network when, for example, it determines that the at least one other short-range wireless network is available and preferred for use.

In the same or a different embodiment, the at least one application (e.g., executed by the application processor in the device) is to control the communication processor at least in regard to conveying information between the at least one other device and the WAN. For example, the at least one application may be to cause the communication processor to enter a mode for conveying information between the at least one other device and the WAN. The at least one application may also be to determine if conveying information between the at least one other device and the WAN is permitted. In an example implementation, instructions may be received at the communication processor instructing the device to enter a mode for conveying information between the at least one other device and the WAN. Configuring the communication processor to convey information between the at least one other device and the WAN may then be followed by conveying information between the at least one other device and the WAN.

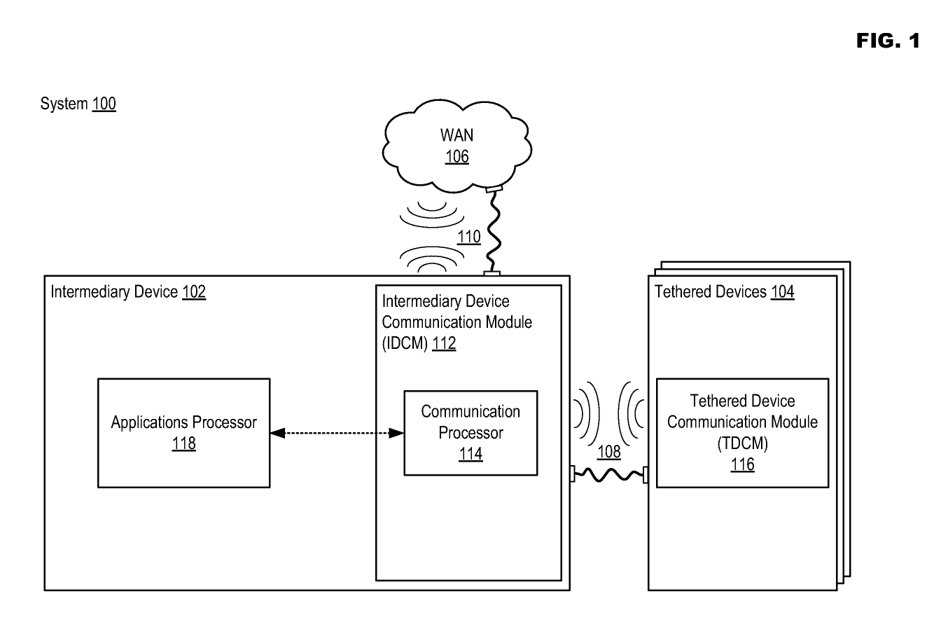

FIG. 1 illustrates an example of offloading tethering-related communication processing in accordance with at least one embodiment of the present disclosure. System 100 may include, for example, intermediary device 102, one or more tethered devices 104 and WAN 106. The one or more tethered devices 104 may be coupled to intermediary device 102 via wired or wireless link 108, and intermediary device 102 may be coupled to WAN 106 via wired or wireless link 110. In general, this configuration allows one or more tethered devices 104 to interact with each other through wired or wireless link 108 to intermediary device 102, and further, one or more tethered devices 104 may also be able to interact with WAN 106 through wired or wireless link 110.

For example, intermediary device 102 may comprise intermediary device communication module (IDCM) 112 configured to communicate with a tethered device communication module (TDCM) 116 in each of one or more tethered devices 104 via wired or wireless links 108. IDCM 112 may also be able to communicate with WAN 106 via wired or wireless link 110. IDCM 112 may comprise, or may at least be coupled to, communication processor 114, which may facilitate interaction between devices making up one or more tethered devices 104 (e.g., device-to-device communication) and between one or more tethered devices 104 and WAN 106 (device-to-WAN communication). In particular, communication processor 114 may route communication packets (e.g., in conjunction with any necessary packet processing, translation, conversion, etc.) received from tethered device 104 to another tethered device 104, to destinations (e.g. applications) within intermediary device 102 or to WAN 106, and may route communication packets received from WAN 106 to one or more tethered devices 104 or to destinations within intermediary device 102.

In one embodiment, intermediary device 102 may further include applications processor 118 that is separate from communication processor 114. The separation between communication processor 114 and applications processor 118 does not require that they be separate components in intermediary device 102. Communication processor 114 and applications processor 118 may also be, for example, two processing engines (e.g., cores) within the same processing component, wherein communication processor 114 may be coupled to at least IDCM 112 and dedicated to managing communication in intermediary device 102. Applications processor 118 may execute various applications in intermediary device 102, wherein at least one of the applications may be configured to interact with communication processor 114. The at least one application may be able to perform various management functions with respect to communication processor 114 including, for example, determining whether tethering is permitted in intermediary device 102 (e.g., in view of provider restrictions), providing security, activating tethering functionality, etc. In so doing, operations associated with tethering setup, configuration, enabling, etc. may be logically separated from per-packet processing (e.g. NAT, forwarding, firewalling, etc.). This logical separation of operations results in a division in processing responsibility in intermediary device 102, and consequently, various benefits not seen in existing implementations in which all tethering related operations are performed by a single processor (e.g., application processor 118).

For example, separating communication processor 114 from applications processor 118 may enhance efficiency, performance and security in device in intermediary device 102. It terms of efficiency, since communication processor 114 may be dedicated only to communications management it may be a smaller processor such as, for example, an offload or embedded processing core in a communication chipset. Smaller processors may consume less power than processors generally purposed for managing operations in in intermediary device 102 (e.g., applications processor 118). Likewise, less power may be expended transmitting packets across interfaces or memory copies by performing per-packet processing in communications processor 114. Thus, if applications processor 118 is able to remain partially or totally uninvolved in tethering operations, processing resources and power may be conserved in intermediary device 102. Moreover, because applications processor 118 is not required to handle communications-related processing, tethering operations may become a background operation that does not affect general performance in intermediary device 102. For example, application processor 118 may remain partially or totally dormant (e.g., in sleep mode) during tethering, and may then be fully available for other required/desired operations. Finally, separating communication functionality from general device operations may create boundaries usable for securing tethering connections and the device itself. Malware, viruses, etc. that may be present in one or more tethered devices 104 may be limited from gaining access to general device operations handled in applications processor 118, and likewise, malware, viruses, etc. that may be present in application processor 118 may be limited from gaining access to one or more tethered devices 104. In addition, separating general processing from communication control may make it more difficult for those desiring to overcome provider-installed tethering controls by, for example, “rooting” (e.g., in an android device) or “jailbreaking” (e.g., in an iOS device). Since the communication processing may be handled by a separate processing, overcoming the general operating system (OS) control features of intermediary device 102 may not expose any controls (e.g., tethering access control) that may be built into communication processor 114. In some embodiments, the communication processor 114 may identify and prevent unauthorized tethering or forwarding of traffic between interfaces (e.g., accomplished by applications at the application processor 118) in violation of, for example, policies or preferences defined by the user, Enterprise, Service Provider, etc.

Embodiments consistent with the present disclosure may include some involvement of applications processor 118 in tethering operations (e.g., partial offload) or no involvement by applications processor 118 in tethering operations (e.g., total offload). For example, in one embodiment some control-related interaction may occur between application processor 118 and communication processor 114 to coordinate actions between the two. For example, applications processor 118 may be configured to execute applications that cause tethering to be activated or deactivated in intermediary device 102, to control access to tethering (e.g., based on whether a device user has contracted with the service provider to use tethering functionality in intermediary device 102), to provide additional security features related to tethering, to push out route table updates to communication processor 114, etc. By pushing out updates of the route table to communication processor 114, complex service provider policies and application preferences pertaining to the handling of multiple uplink connections during concurrent uplink operation can be satisfied. It is also possible for application processor 118 to be relieved of responsibility for control-related interaction with communication processor 114 and instead act opportunistically due to, for example, the occurrence of errors, interrupts, events, etc. In another embodiment, communication processor 114 may be programmed to act autonomously and, for example, sense the requirement to activate or deactivate tethering, to access and/or update security and provider policy information directly, etc. and thus, in at least one embodiment applications processor 118 need not be involved in tethering operations.

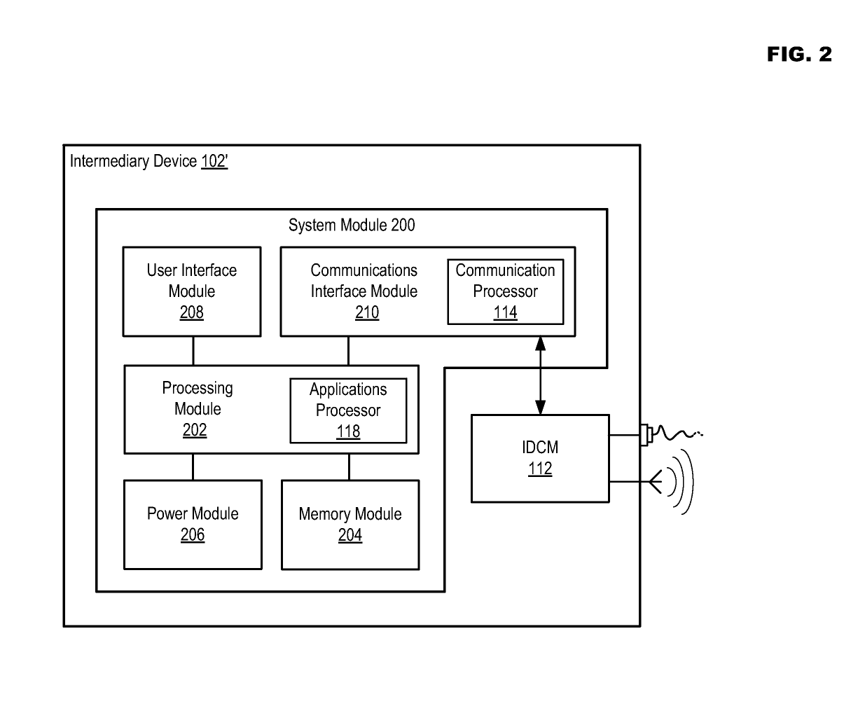

FIG. 2 illustrates an example configuration for intermediary device 102′ usable in accordance with at least one embodiment of the present disclosure. Intermediary device 102′ is an example of equipment that may be used to implement system 100 illustrated in FIG. 1. While embodiments consistent with the present disclosure may be implemented in this manner, these embodiments are not limited only to the example configuration shown in FIG. 2. Intermediary device 102′ may comprise system module 200 configured to manage device operations. System module 200 may include, for example, processing module 202, memory module 204, power module 206, user interface module 208 and communication interface module 210 that may be configured to interact with IDCM 112. In the example disclosed in FIG. 2, processing module 202 may include applications processor 118, while communications interface module 112 may include communication processor 114. While IDCM 112 is shown as separate from system module 200, this is merely for the sake of explanation herein. Some or all of the functionality associated with IDCM 112 may also be incorporated within system module 200.

In intermediary device 102′, processing module 202 may comprise one or more processors (e.g., including applications processor 118) situated in separate components, or alternatively, may comprise one or more processing cores embodied in a single component (e.g., in a System-on-a-Chip (SOC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in intermediary device 102′. Some or all of the functionality commonly associated with the support circuitry may also be included in the same physical package as the processor (e.g., an SOC package like the Sandy Bridge integrated circuit available from the Intel Corporation).

Processing module 202 may be configured to execute various instructions in intermediary device 102′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 206 may comprise random access memory (RAM) or read-only memory (ROM) in a fixed or removable format. RAM may include memory configured to hold information during the operation of intermediary device 102′ such as, for example, static RAM (SRAM) or Dynamic RAM (DRAM). ROM may include memories such as bios memory configured to provide instructions when intermediary device 102′ activates, programmable memories such as electronic programmable ROMs (EPROMS), Flash, etc. Other fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), etc. Power module 206 may include internal power sources (e.g., a battery) and/or external power sources (e.g., electromechanical or solar generator, power grid, fuel cells, etc.), and related circuitry configured to supply intermediary device 102′ with the power needed to operate.

User interface module 208 may comprise componentry configured to allow users to interact with intermediary device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and various output mechanisms (e.g., speakers, displays, lighted/flashing indicators, electromechanical components for vibration, motion, etc.). Communication interface module 210 may include communication processor 114, and may be configured to handle packet routing and other control functions for communication module 214, which may include resources configured to support wired and/or wireless communications. Wired communications may include serial and parallel wired mediums such as, for example, Ethernet, Universal Serial Bus (USB), Firewire, Digital Visual Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g., Bluetooth, WLAN, Wi-Fi, etc.) and long range wireless mediums (e.g., cellular, satellite, etc.). In one embodiment, communication interface module 212 may be configured to prevent wireless communications that are active in communication module 214 from interfering with each other. In performing this function, communication interface module 212 may schedule activities for communication module 214 based on, for example, the relative priority of messages awaiting transmission. While communication processor 114 is illustrated as included in communications interface module 210, it may also be situated in IDCM 112 (e.g., as shown in FIG. 1). For example, communications interface module 210 and/or IDCM 112 may be encompassed in a chip set including communication processor 114 and one or more wired and/or wireless interface devices (e.g., transmitters, receivers, transceivers, wireless radios, etc.). It may also be possible for applications processor 118 and communication processor 114 to be functionally separate but physically embodied in the same device. For example, applications processor 118 and communication processor 114 may be separate processing engines (e.g., processors or processor cores) within the same processing device (microprocessor, SOC, etc.).

In general, when one or more tethered devices 104 successfully associate and optionally authenticate to a tether (e.g., via Wi-Fi), they receive a DHCP offer from access point software (e.g., soft AP) executing in intermediary device 102. Included in this DHCP offer are an offered IP address for the tethered device, subnet mask, DNS Server, and a default gateway. The default gateway address (e.g., 192.168.1.1) may be associated with a virtual interface in the soft AP software executing on intermediary device 102. This virtual interface will also have a MAC address associated with it. This enables one or more tethered devices 104 to forward all off-subnet (e.g., Internet-destined) packets to the default gateway on Intermediary device 102. The soft AP will receive the packets, perform functions such as firewalling and network address translation (NAT), and in most cases forward these packets on to WAN 106. Packets originating with one tethered device 104 and intended for another tethered device 104 or intermediary device 102 may likewise require routing through intermediary device 102. Traditionally, this is all done by applications processor 118.

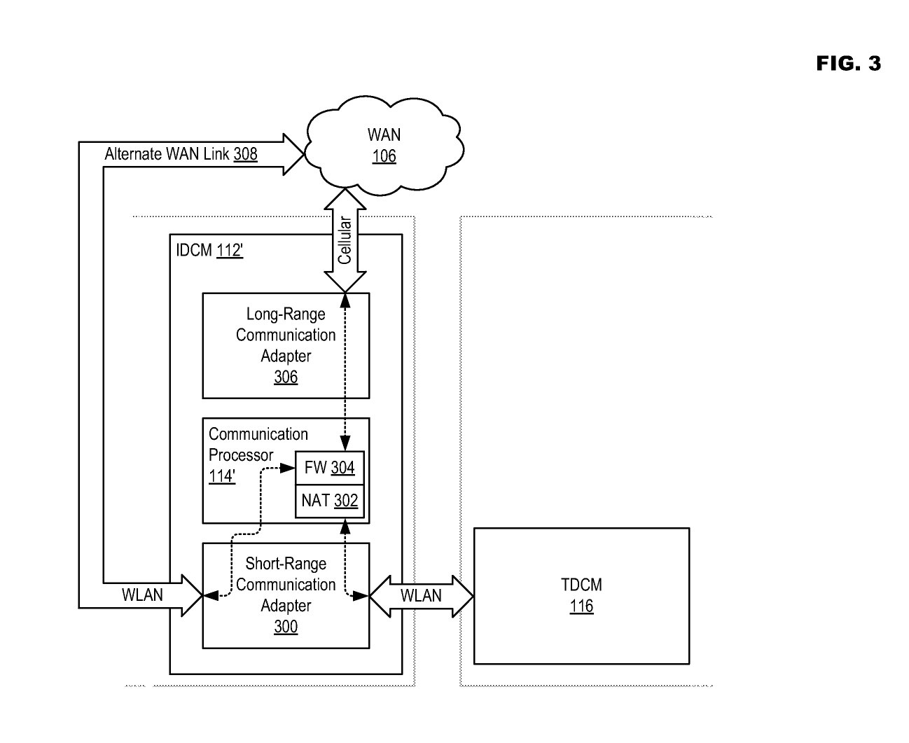

FIG. 3 illustrates a communication example in accordance with at least one embodiment of the present invention. In FIG. 3, IDCM 112′ includes communication processor 114′ short-range communication adapter 300 and long range communication adapter 206. Communication processor 114′ includes NAT resources 302 and firewall (FW) 304. TDCM 116 may interact with short-range communication adapter 300 via a short-range wireless communication (e.g., a WLAN link). Communication packets received in short-range communication adapter 300 may initially be screened to determine their destination. Communication packets having a destination address (e.g., intended for one of the one or more tethered devices 104) do not need to go through NAT since they are all locally-administered private addresses. These communication packets may simply be forwarded back out the WLAN interface after simple “stateful” (e.g., connection-aware) firewalling that may be implemented in communication processor 114′ as shown at 304. Stateful firewalling allows only those communication packets related to active communications to be filtered, which may reduce the number of unsolicited communication packets that have to be handled by intermediary device 102 and helps to conserve processing and power resources. Firewalling may also improve security and/or privacy on intermediary device 102, one or more tethered devices 104 and/or WAN 106 by preventing unintended, unauthorized, or potentially harmful communications.

In one embodiment, NAT 302 may also be offloaded to communication processor 114′. WAN-side addressing and ports used for NAT are invisible to one or more tethered devices 104, and thus, there is no perceived difference between application processor 118 implementing NAT 302 and communication processor 114′ implementing NAT 302. Further, in some embodiments both application processor 118 and communication processor 114′ may concurrently perform NAT operations wherein some communication packets or flows may be handled by application processor 118 while others are handled by communication processor 114′. In this instance, it may be beneficial to ensure that consistent NAT operation occurs independently of the physical processing location of the NAT operations occurring at 302. During normal operation, communication packets outbound from one or more tethered clients 104 to WAN 106 will cause NAT 302 to establish new translation table entries managed at communication processor 114′, which may translate the communication packets to the desired source address and source ports. Communication packets inbound from WAN 106 (e.g., into long-range communication adapter 306 via a cellular data network such as a Long Term Evolution (LTE) network) intended for one or more tethered devices 104 will match the translation rules and have their destination addresses and ports translated per the table (e.g., the inverse of the outbound translation). Again, stateful firewalling may also be implemented on all ingress packets as shown at 304 to block unsolicited packets for improved power conservation, security, etc. This use case is particularly common in the “personal cloud” context wherein intermediary device 102 and one or more tethered clients 104 may share and transfer services, context and experiences amongst themselves. Packets may also be filtered from applications executing in intermediary device 102 to one or more tethered devices 104 via firewall 304. The use of a stateful firewall may reduce the number of unsolicited packets to be processed by applications processor 118 and/or one or more tethered clients 104.

In the same or another embodiment, communication processor 114′ may also be able to take advantage of alternative connection paths to WAN 106, when available. For example, in many instances the maintenance of a short-range wireless link (e.g., WLAN) takes substantially less power than the maintenance of a long-range wireless link (e.g., a cellular 3G or 4G data link). Therefore, it may be beneficial to utilize short-range links when possible. As shown at 308, when an alternate short-range link (e.g., WLAN to a local AP) becomes available to communicate with WAN 106, communication processor 114′ may be able to determine that an another link is available and preferred (e.g., based on information provided by short-range communication adapter 300, based on a Quality of Experience assessment of the available links, etc.) and to automatically cause packets to be rerouted to WAN 106 via alternate link 308. The cellular link to WAN 106 may be discontinued or placed in a lower (e.g., standby) state until again needed, allowing intermediary device 102 to conserve power. As a result, intermediary device 102 may, for example, interact with WAN 106 using alternate WLAN link 308 (e.g., via a WLAN AP) and may simultaneously act as a WLAN AP to one or more tethered devices 104 that are associated and able to send and receive data to one another, to intermediary device 102, to WAN 106, etc.

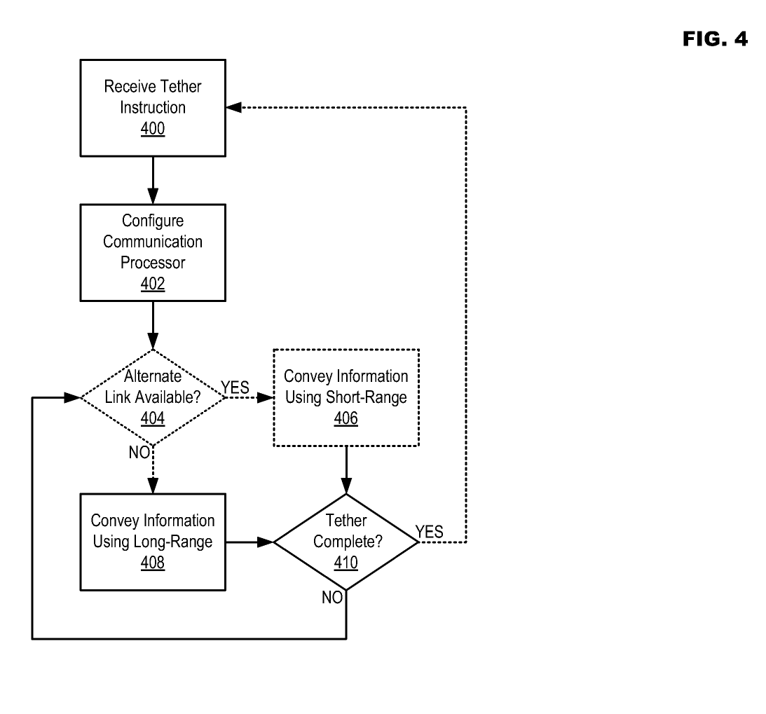

FIG. 4 illustrates example operations for offloading tethering-related communication processing in accordance with at least one embodiment of the present disclosure. In operation 400 a communication processor may receive instructions indicating to establish tethering in an intermediary device. The instructions may be received from, for example, an application being executed by an application processor also residing in the intermediary device. In operation 402 the communication processor may be configured. Configuration of the communication processor may include, for example, the activation, configuration, updating, etc. of NAT resources, at least one translation table for use in routing communication packets between one or more tethered devices and a WAN. A firewall may also be configured in the communication processor (e.g., configuration may be performed via user interactions or over-the-network provisioning from an enterprise, server provider, etc.).

Operations 404 and 406 may be optional based on, for example, the configuration of the intermediary device, the capabilities of the intermediary device, etc. In optional operation 404, a determination may be made as to whether an alternate link is available and preferred between the intermediary device and WAN. For example, a primary link (e.g., a long-range wireless data connection such as via an LTE wireless network) may consume more energy than accessing the WAN via a local wireless AP via WLAN communication. If in operation 404 it is determined that an alternate link is available, then in operation 406 information may be conveyed between the at least one tethered device and the WAN via the alternate connection (e.g., the short-range wireless link). Otherwise, if it is determined in operation 404 that no alternative link is available, then in operation 408 information may be conveyed between the at least one tethered device and the WAN via the primary connection (e.g., the long-range wireless link). A determination may then be made in operation 410 as to whether tethering is complete. If it is determined in operation 410 that tethering is not complete (e.g., there is still more information to convey between the at least one tethered device and the WAN), then in optional operation 404 a determination may again be made as to whether an alternative link is available and preferred. Otherwise, operation 410 may be optionally be followed by a return to operation 400 to await the receipt of further instructions.

While FIG. 4 illustrates various operations according to an embodiment, it is to be understood that not all of the operations depicted in FIG. 4 are necessary for other embodiments. Indeed, it is fully contemplated herein that in other embodiments of the present disclosure, the operations depicted in FIG. 4, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to offloading tethering-related communication processing. In general, a communication processor in an intermediary device may be responsible for handling communication between tethered devices and a wide area network (WAN) like the Internet. In offloading responsibility for managing tethered devices to the communication processor, other processing resources (e.g., an applications processor) in the intermediary device may be both uninvolved and potentially totally isolated from the tethering, allowing the intermediary device to conserve power/processing resources, maintain better security, etc. An intermediary device may comprise, for example, a communication module to communicate with at least one other device and a WAN, a communication processor to control how information may be conveyed between the at least one other device and the WAN and an application processor, separate from the communication processor, to execute at least one application in the device.

The following examples pertain to further embodiments. In one example there is provided a device. The device may include a communication module to communicate with at least one other device and a wide area network (WAN), a communication processor to control how information is conveyed between the at least one other device and the WAN, and an applications processor, separate from the communication processor, to execute at least one application in the device.

The above example device may be further configured, wherein the communication processor comprises network address translation (NAT) resources and at least one translation table to route communication packets between the at least one other device and the WAN. In this configuration the example device may be further configured, wherein the communication processor comprises a firewall to filter at least the communication packets between the at least one other device and the WAN.

The above example device may be further configured, alone or in combination with the above further configurations, wherein the communication module is to communicate with the at least one other device via a short-range wireless network, is to communicate with the WAN via a long-range wireless network, and the communication processor is to route communication packets between the short-range and the long-range wireless networks. In this configuration the example device may be further configured, wherein the communication module is to communicate with the WAN via at least one other short-range wireless network, the communication processor is to cause the communication module to communicate with the WAN using the at least one other short-range wireless network instead of the long-range wireless network based on a determination that the at least one other short-range wireless network is available and preferred for use.

The above example device may be further configured, alone or in combination with the above further configurations, wherein the at least one application is to control the communication processor at least in regard to conveying information between the at least one other device and the WAN. In this configuration the example device may be further configured, wherein the at least one application is to cause the communication processor to enter a mode for conveying information between the at least one other device and the WAN. In this configuration the example device may be further configured, wherein the at least one application is to determine if conveying information between the at least one other device and the WAN is permitted.

In another example there is provided a method. The method may include receiving instructions at a communication processor in a device to enter a mode for conveying information between at least one other device and a wide area network (WAN), the communication processor being separate from an applications processors in the device, configuring the communication processor to convey information between the at least one other device and the WAN, and conveying information between the at least one other device and the WAN.

The above example method may be further configured, wherein the instructions are received from at least one application to control the communication processor executed by the applications processor.

The above example method may be further configured, alone or in combination with the above further configurations, wherein configuring the communication processor comprises configuring network address translation (NAT) resources and at least one translation table in the communication processor to route communication packets between the at least one other device and the WAN. In this configuration the example method may be further configured, wherein configuring the communication processor comprises configuring a firewall in the communication processor to filter at least the communication packets between the at least one other device and the WAN.

The above example method may be further configured, alone or in combination with the above further configurations, wherein conveying the information comprises establishing a connection to the at least one device via a short-range wireless network, establishing a connection to the WAN via a long-range wireless network, and conveying communication packets between the short-range and long-range wireless networks. In this configuration the example method may be further configured, wherein conveying information comprises establishing a connection to the WAN via at least one other short-range wireless network instead of the long-range wireless network based on determining that the at least one other short-range wireless network is available and preferred for use.

In another example there is provided a system comprising at least a communication processor, the system being arranged to perform any of the above example methods.

In another example there is provided a chipset arranged to perform any of the above example methods.

In another example there is provided at least one machine readable medium comprising a plurality of instructions that, in response to be being executed on a computing device, cause the computing device to carry out any of the above example methods.

In another example there is provided a device configured for offloading tethering-related communication processing arranged to perform any of the above example methods.

In another example there is provided a device having means to perform any of the above example methods.

In another example there is provided at least one machine-readable storage medium having stored thereon individually or in combination, instructions that when executed by one or more processors result in the system carrying out any of the above example methods.

In another example there if provided a device. The device may include a communication module to communicate with at least one other device and a wide area network (WAN), a communication processor to control how information is conveyed between the at least one other device and the WAN, and an applications processor, separate from the communication processor, to execute at least one application in the device.

The above example device may be further configured, wherein the communication processor comprises network address translation (NAT) resources, at least one translation table to route communication packets between the at least one other device and the WAN and a firewall to pass at least the communication packets between the at least one other device and the WAN.

The above example device may be further configured, alone or in combination with the above further configurations, wherein the communication module is to communicate with the at least one other device via a short-range wireless network, is to communicate with the WAN via a long-range wireless network, and the communication processor is to route communication packets between the short-range and the long-range wireless networks. In this configuration the example device may be further configured, wherein the communication module is to communicate with the WAN via at least one other short-range wireless network, the communication processor is to cause the communication module to communicate with the WAN using the at least one other short-range wireless network instead of the long-range wireless network based on a determination that the at least one other short-range wireless network is available and preferred for use.

The above example device may be further configured, alone or in combination with the above further configurations, wherein the at least one application is to control the communication processor at least in regard to conveying information between the at least one other device and the WAN. In this configuration the example device may be further configured, wherein the at least one application is to cause the communication processor to enter a mode for conveying information between the at least one other device and the WAN. In this configuration the example device may be further configured, wherein the at least one application is to determine if conveying information between the at least one other device and the WAN is permitted.

In another example there is provided a method. The method may include receiving instructions at a communication processor in a device to enter a mode for conveying information between at least one other device and a wide area network (WAN), the communications processor being separate from an applications processors in the device, configuring the communication processor to convey information between the at least one other device and the WAN, and conveying information between the at least one other device and the WAN.

The above example method may be further configured, wherein the instructions are received from at least one application to control the communications processor executed by the applications processor.

The above example method may be further configured, alone or in combination with the above further configurations, wherein configuring the communication processor comprises configuring network address translation (NAT) resources, at least one translation table in the communication processor to route communication packets between the at least one other device and the WAN, and configuring a firewall in the communication processor to pass at least the communication packets between the at least one other device and the WAN.

The above example method may be further configured, alone or in combination with the above further configurations, wherein conveying the information comprises establishing a connection to the at least one device via a short-range wireless network, establishing a connection to the WAN via a long-range wireless network, and conveying communication packets between the short-range and long-range wireless networks. In this configuration the example method may be further configured, wherein conveying information comprises establishing a connection to the WAN via at least one other short-range wireless network instead of the long-range wireless network based on determining that the at least one other short-range wireless network is available and preferred for use.

In another example there is provided a system comprising at least a communication processor, the system being arranged to perform any of the above example methods.

In another example there is provided a chipset arranged to perform any of the above example methods.

In another example there is provided at least one machine readable medium comprising a plurality of instructions that, in response to be being executed on a computing device, cause the computing device to carry out any of the above example methods.

In another example there is provided a device. The device may include a communication module to communicate with at least one other device and a wide area network (WAN), a communication processor to control how information is conveyed between the at least one other device and the WAN, and an applications processor, separate from the communication processor, to execute at least one application in the device.

The above example device may be further configured, wherein the communication processor comprises network address translation (NAT) resources and at least one translation table to route communication packets between the at least one other device and the WAN. In this configuration the example device may be further configured, wherein the communication processor comprises a firewall to filter at least the communication packets between the at least one other device and the WAN.

The above example device may be further configured, alone or in combination with the above further configurations, wherein the communication module is to communicate with the at least one other device via a short-range wireless network, is to communicate with the WAN via a long-range wireless network, and the communication processor is to route communication packets between the short-range and the long-range wireless networks. In this configuration the example device may be further configured, wherein the communication module is to communicate with the WAN via at least one other short-range wireless network, the communication processor is to cause the communication module to communicate with the WAN using the at least one other short-range wireless network instead of the long-range wireless network based on a determination that the at least one other short-range wireless network is available and preferred for use.

The above example device may be further configured, alone or in combination with the above further configurations, wherein the at least one application is to control the communication processor at least in regard to conveying information between the at least one other device and the WAN. In this configuration the example device may be further configured, wherein the at least one application is to cause the communication processor to enter a mode for conveying information between the at least one other device and the WAN. In this configuration the example device may be further configured, wherein the at least one application is to determine if conveying information between the at least one other device and the WAN is permitted.

In another example there is provided a method. The method may include receiving instructions at a communication processor in a device to enter a mode for conveying information between at least one other device and a wide area network (WAN), the communication processor being separate from an applications processors in the device, configuring the communication processor to convey information between the at least one other device and the WAN, and conveying information between the at least one other device and the WAN.

The above example method may be further configured, wherein the instructions are received from at least one application to control the communication processor executed by the applications processor.

The above example method may be further configured, alone or in combination with the above further configurations, wherein configuring the communication processor comprises configuring network address translation (NAT) resources and at least one translation table in the communication processor to route communication packets between the at least one other device and the WAN. In this configuration the example method may be further configured, wherein configuring the communication processor comprises configuring a firewall in the communication processor to filter at least the communication packets between the at least one other device and the WAN.

The above example method may be further configured, alone or in combination with the above further configurations, wherein conveying the information comprises establishing a connection to the at least one device via a short-range wireless network, establishing a connection to the WAN via a long-range wireless network, and conveying communication packets between the short-range and long-range wireless networks. In this configuration the example method may be further configured, wherein conveying information comprises establishing a connection to the WAN via at least one other short-range wireless network instead of the long-range wireless network based on determining that the at least one other short-range wireless network is available and preferred for use.

In another example there is provided a system. The system may include means for receiving instructions at a communication processor in a device to enter a mode for conveying information between at least one other device and a wide area network (WAN), the communication processor being separate from an applications processors in the device, means for configuring the communication processor to convey information between the at least one other device and the WAN, and means for conveying information between the at least one other device and the WAN.

The above example system may be further configured, wherein the instructions are received from at least one application to control the communication processor executed by the applications processor.

The above example system may be further configured, alone or in combination with the above further configurations, wherein configuring the communication processor comprises configuring network address translation (NAT) resources and at least one translation table in the communication processor to route communication packets between the at least one other device and the WAN. In this configuration the example system may be further configured, wherein configuring the communication processor comprises configuring a firewall in the communication processor to filter at least the communication packets between the at least one other device and the WAN.

The above example system may be further configured, alone or in combination with the above further configurations, wherein conveying the information comprises establishing a connection to the at least one device via a short-range wireless network, establishing a connection to the WAN via a long-range wireless network, and conveying communication packets between the short-range and long-range wireless networks. In this configuration the example system may be further configured, wherein conveying information comprises establishing a connection to the WAN via at least one other short-range wireless network instead of the long-range wireless network based on determining that the at least one other short-range wireless network is available and preferred for use.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A device, comprising:
a communication module to communicate with at least one other device and a wide area network (WAN);
a communication processor to control how information is conveyed between the at least one other device and the WAN; and
an applications processor, separate from the communication processor, to execute at least one application in the device.

2. The device of claim 1, wherein the communication processor comprises network address translation (NAT) resources and at least one translation table to route communication packets between the at least one other device and the WAN.

3. The device of claim 2, wherein the communication processor comprises a firewall to filter at least the communication packets between the at least one other device and the WAN.

4. The device of claim 1, wherein the communication module is to communicate with the at least one other device via a short-range wireless network, is to communicate with the WAN via a long-range wireless network, and the communication processor is to route communication packets between the short-range and the long-range wireless networks.

5. The device of claim 4, wherein the communication module is to communicate with the WAN via at least one other short-range wireless network, the communication processor is to cause the communication module to communicate with the WAN using the at least one other short-range wireless network instead of the long-range wireless network based on a determination that the at least one other short-range wireless network is available and preferred for use.

6. The device of claim 1, wherein the at least one application is to control the communication processor at least in regard to conveying information between the at least one other device and the WAN.

7. The device of claim 6, wherein the at least one application is to cause the communication processor to enter a mode for conveying information between the at least one other device and the WAN.

8. The device of claim 6, wherein the at least one application is to determine if conveying information between the at least one other device and the WAN is permitted.

9. A method, comprising:
receiving instructions at a communication processor in a device to enter a mode for conveying information between at least one other device and a wide area network (WAN), the communication processor being separate from an applications processors in the device;
configuring the communication processor to convey information between the at least one other device and the WAN; and
conveying information between the at least one other device and the WAN.

10. The method of claim 9, wherein the instructions are received from at least one application to control the communication processor executed by the applications processor.

11. The method of claim 9, wherein configuring the communication processor comprises configuring network address translation (NAT) resources and at least one translation table in the communication processor to route communication packets between the at least one other device and the WAN.

12. The method of claim 11, wherein configuring the communication processor comprises configuring a firewall in the communication processor to filter at least the communication packets between the at least one other device and the WAN.

13. The method of claim 9, wherein conveying the information comprises establishing a connection to the at least one device via a short-range wireless network, establishing a connection to the WAN via a long-range wireless network, and conveying communication packets between the short-range and long-range wireless networks.

14. The method of claim 13, wherein conveying information comprises establishing a connection to the WAN via at least one other short-range wireless network instead of the long-range wireless network based on determining that the at least one other short-range wireless network is available and preferred for use.

15. At least one machine-readable storage medium having stored thereon, individually or in combination, instructions that when executed by one or more processors result in the following operations comprising:
receiving instructions at a communication processor in a device to enter a mode for conveying information between at least one other device and a wide area network (WAN), the communication processor being separate from an applications processors in the device;
configuring the communication processor to convey information between the at least one other device and the WAN; and
conveying information between the at least one other device and the WAN.

16. The medium of claim 15, wherein the instructions are received from at least one application to control the communication processor executed by the applications processor.

17. The medium of claim 15, wherein configuring the communication processor comprises configuring network address translation (NAT) resources and at least one translation table in the communication processor to route communication packets between the at least one other device and the WAN.

18. The medium of claim 17, wherein configuring the communication processor comprises configuring a firewall in the communication processor to filter at least the communication packets between the at least one other device and the WAN.

19. The medium of claim 15, wherein conveying the information comprises establishing a connection to the at least one device via a short-range wireless network, establishing a connection to the WAN via a long-range wireless network, and conveying communication packets between the short-range and long-range wireless networks.

20. The medium of claim 19, wherein conveying information comprises establishing a connection to the WAN via at least one other short-range wireless network instead of the long-range wireless network based on determining that the at least one other short-range wireless network is available and preferred for use.
